(19) United States
(12) Patent Application Publication
(10) Pub. No.: US 2011/0016968 A1
(43) Pub. Date: Jan. 27, 2011

(54) Metering device

(76) Inventors: Heinz-Dieter Eichholz, Iserlohn (DE); Gerold Jans, Waldburg (DE); Roland Schmalz, Waldburg (DE); Ba Loc Nguyen, Neukirch (DE); Michael Pasternak, Lindau (DE)

Correspondence Address: William D. Breneman, Esq.;BRENEMAN & GEORGES, 3150 Commonwealth Avenue, Alexandria, VA, 22305, US

(21) Appl. No.: 12/805,175

(22) Filed: Jul. 15, 2010

(30) Foreign Application Priority Data
Jul. 16, 2009 (DE) 10 2009 033 589.7

(51) Int. Cl. G01F 5/00

(52) U.S. Cl. 73/203

(57) ABSTRACT

A metering device (1) is proposed for metering a fluid and for conducting a fluid, with a pre-metering chamber (3) for portioning the fluid. In order to permit an improved, in particular precise metering, at least one separating element (8) which is buoyant in the fluid because of buoyancy is provided in the pre-metering chamber (3).

The invention relates to a metering device for metering a fluid and for conducting a fluid in accordance with the precharacterizing clause of claim 1.

A metering valve for metering liquid agents in domestic appliances is known from the prior art, for example from DE 198 21 414 A1, in which a liquid medium can be metered by means of a valve tappet via a pre-metering chamber and an adjoining valve chamber and can finally be dispensed to the outside.

It is the object of the invention to propose a metering device which permits improved, in particular precise, metering.

Starting from a metering device of the type mentioned at the beginning, the object is achieved by the characterizing features of claim 1.

Advantageous embodiments and developments of the invention are possible by means of the measures referred to in the dependent claims.

Accordingly, a metering device according to the invention is distinguished in that a separating element which is buoyant in the fluid because of buoyancy is provided in the pre-metering chamber. In this case, the pre-metering chamber serves essentially to portion the fluid. Ultimately, approximately the quantity of fluid pre-metered in the pre-metering chamber is discharged when the fluid is dispensed out of the metering device. In this case, the buoyant separating element essentially has the task of separating that part of the fluid which is to be finally metered and dispensed. This measure has the advantage, inter alia, that more precise metering can be permitted. The separating element may also have the effect here of a throttle. Furthermore, the separating element may optionally also prevent impurities in the fluid from passing in a reverse flow in the fluid line, for example, into the stored fluid volume.

The term “fluid” describes a liquid, but also a gas.

The buoyancy of a body in the fluid is achieved by the body having a lower density than the fluid. This is generally achieved through selection of the material of the buoyant body. For example, it is possible to design the separating element itself as a buoyant body. However, there is also the possibility of providing a separate floating body which is buoyant in the fluid because of buoyancy and is arranged or designed in such a manner that it can carry along the separating element when floating. This can be realized, for example, such that the separating element rests on top of the floating body in the direction of gravity. If appropriate, however, the separating element itself may also be fastened to the floating body. In this case, it is possible, but not absolutely necessary, for the separating element itself to be buoyant. If the separating element itself is designed as a buoyant body, this affords the advantage of fewer components being required to manufacture the metering device. However, it may also be advantageous to provide a separate floating body in addition to the actual separating element, for example if special material properties are required to produce the separating element or if the separating element is better formed separately for other reasons.

In an advantageous exemplary embodiment, the separating element is therefore movable in the direction of gravity. Since the buoyancy itself acts in the opposite direction to the direction of gravity, it is advantageous to provide the separating element with corresponding freedom of movement in said direction. In particular, as a result, the friction of the separating element against the walls of the pre-metering chamber can be reduced, which can also result in the risk of the separating element tilting being reducible.

In particular, it may be desirable to use the metering device in conjunction with a tank or a storage chamber for storing the fluid. Accordingly, it is advantageous to provide a storage chamber for storing the fluid. The conducting of a fluid can be designed in such a manner that the pre-metering chamber directly adjoins the storage chamber and the storage chamber is therefore connected to the pre-metering chamber via an inlet opening.

In particular whenever fluid is conducted by gravity, in an operating position of the metering device, the storage chamber can advantageously always be at least partially arranged above the pre-metering chamber in the direction of gravity. In the operating position means that the metering device maintains a fixed orientation during the operation thereof or during normal use in order to be able to operate correctly or in a manner particularly suitable for the operation. This is the case, for example, when the fluid is intended to flow in the fluid line from the storage chamber into the pre-metering chamber via an inlet opening.

Furthermore, in a development of the invention, the separating element has a passage for the throughflow of fluid. This affords the advantage that, if the separating element is intended to rise by means of buoyancy, it has to displace the fluid correspondingly. When the separating element rises, some of the fluid therefore has to be displaced and has to flow to the previous location at which the separating element was previously located. Said passage may also be selected to be comparatively small in cross-sectional area such that the time during which the fluid can flow through the passage is relatively large, if appropriate. This furthermore also increases the time required for the buoyancy of the separating element. If the passage is selected to be comparatively small, this affords the advantage that the separating element is initially carried along in the fluid flow during emptying of the pre-metering chamber. If the buoyancy were very much greater than the corresponding effect of the fluid flow, then, under some circumstances, during the emptying, the separating element would remain virtually always unchanged at the same height in the direction of gravity. Furthermore, a small passage affords the advantage that the smaller it is selected to be, the better the separation of the fluid stored in the storage chamber from the fluid which is stored in the pre-metering chamber and is located, for example, below the separating element in the direction of gravity.

The passage can in particular be ensured by, in an embodiment of the invention, the cross-sectional area of the separating element being selected to be smaller than the cross-sectional area of the pre-metering chamber. This has the advantage that, for example, when the separating element rises as a consequence of the buoyancy, the liquid flows around the separating element on the outside, i.e. between the separating element and the walls of the pre-metering chamber, thus enabling frictional effects against the walls of the pre-metering chamber by the separating element to be kept relatively small or, if appropriate, even not being present at all. In addition, the probability of the separating element tilting between the walls of the pre-metering chamber may, if appropriate, be kept low. A further possibility could consist in using a pierced separating element. In addition, frictional effects can generally also be reduced by the formation of grooves or another special surface treatment.

In order, for example, to avoid tilting, it may be advantageous in particular, in a variant embodiment of the invention, for the interior space of the pre-metering chamber to be of substantially cylindrical design. Accordingly, it could be appropriate, for example in this case, for the separating element to be of spherical design. This also provides a possibility of avoiding tilting as far as possible. Even if a spherical separating element rubs by being in contact with the wall, it should generally be expected that the ball will roll along the walls of the pre-metering chamber and can subsequently be moved further away.

Furthermore, an embodiment of the metering device may comprise a line opening for discharging the fluid to be metered. In particular, it may be advantageous to use the pre-metering chamber merely to portion the fluid to be metered, in order to realize the actual dispensing to the outside of the fluid to be metered in the fluid line by means of a downstream valve for opening and closing the line opening. This has the advantage in particular that the valve can be activated especially for this purpose. Furthermore, a valve chamber designed as a transfer region can be provided between the line opening and the pre-metering chamber. The valve may be switched, for example, under time control, but it is also possible to provide a flow meter, for example in addition to the valve control, the flow meter checking the quantity of fluid to be metered and discharged once again in order thereby to be able once again to improve the fluid-dispensing accuracy. Overall, however, the pre-metering chamber makes it possible essentially for the volume predetermined by this means to be able to be metered. The valve control, for example the switching time which elapses between opening and closing the line opening during the metering operation can depend, for example, on the size of the pre-metering chamber, the viscosity of the fluid, etc. and can be correspondingly designed.

In a particularly advantageous development of the invention, the valve is designed as a bistable valve. “Bistable” means that the valve identifies two stable states in which the corresponding line opening is open or closed. In order to maintain a corresponding state, it is not necessary to permanently supply the valve with corresponding control signals. An advantage of this measure is that the valve can in particular be operated in an energy-saving manner. Depending on the design of the valve, it is also possible, for example in the switched-off state or for transport, to design the valve in such a manner that it assumes a closed position in said cases and, as a result, ensures corresponding leakage protection.

In particular, in one embodiment of the invention, the valve can be designed to be electrically activatable. For example, it is possible to provide a corresponding solenoid valve in which an armature for opening and closing the valve is moved or held in a magnetic field. The magnetic field can be generated, for example, by operation of a coil. Furthermore, corresponding permanent magnets can be present, for example in the armature. The advantage of such an electromechanically operated valve is that this can be activated and controlled in a comparatively simple manner. In addition to a coil, it is also possible to operate the valve via operation of an (electric) motor. The choice of said individual refinements substantially depends on the use of the corresponding metering device.

### EXEMPLARY EMBODIMENT

An exemplary embodiment of the invention is illustrated in the drawing and is described in more detail below with reference to the FIGURE and with further advantages and details being indicated.

In detail,

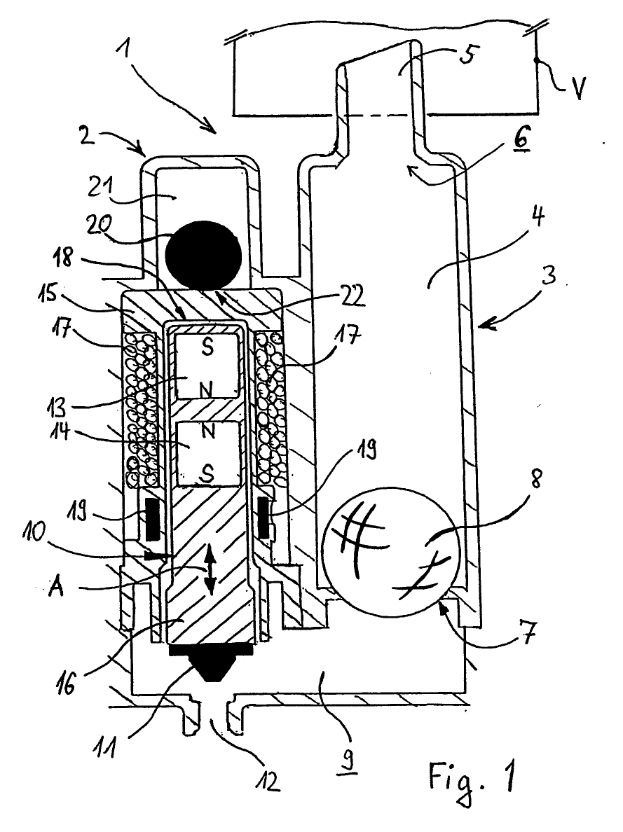

FIG. 1 shows a schematic section through a metering device according to the invention.

FIG. 1 shows a metering device 1 with a valve 2 and a pre-metering chamber 3. In this case, the valve 2 is designed as a bistable valve.

The pre-metering chamber 3 here comprises a pre-metering container 4 which is of cylindrical design. The pre-metering container 4 is connected to a storage container V via an entry 5. The upper edge of the storage container V is cut away in FIG. 1. If said storage container V is designed, for example, as an interchangeable cartridge, then, for example, the metering device 1 can be inserted with the aid of the entry 5 at a location provided therefore. The entry 5 is therefore beveled in FIG. 1 in order, for example upon connection to the storage container V, to be able to pierce a film provided for this purpose on an opening of the storage container V. The entry 5 leads via an opening 6 into the pre-metering container 4.

A further opening 7 is provided at the other end of the cylindrical pre-metering container 4. In FIG. 1, said opening 7 is closed exactly by a separating element 8 which is designed as a ball and is produced, for example, from plastic. The material from which the ball 8 is produced is selected in such a manner that it is buoyant in the corresponding fluid to be metered. However, in principle, there is also the possibility of designing the separating element to be buoyant because of the buoyancy of a separately formed floating body.

One possibility of using a metering device 1 of this type, a valve 2 of this type and a pre-metering chamber 3 of this type is, for example, an embodiment in the form of a metering device for cleaning substances in domestic machines, for example washing machines, dishwashers or the like.

Accordingly, in this variant embodiment of the invention, the ball 8 is designed in such a manner that the material of which it is composed has a sufficiently low density and the buoyant separating element has sufficient buoyancy in order to be buoyant in the liquid to be correspondingly metered, for example a liquid cleaning agent, an aqueous solution of the substance to be metered or, if appropriate, in water.

Furthermore, the diameter of the separating element 8 is selected in such a manner that the cross section through the center of the ball 8 virtually corresponds to the cross section of the cylindrical pre-metering container 4. In this case, however, the diameter of the ball 8 is selected in such a manner that said diameter is somewhat smaller than the diameter of the cylindrical container 4, and therefore the ball 8 can move along the axis of the cylindrical container 4 without sticking in the process. Following the opening 7, there is a transfer region or a valve chamber 9 leading to the valve 2. The valve 2 itself comprises an armature 10 which, in turn, comprises a sealing body 11 with which an outlet opening 12 can be closed.

Consequently, the fluid is overall conducted in such a manner that the fluid to be metered passes out of the storage container V via the entry 5 into the pre-metering chamber 3, in particular into the pre-metering container 4, and, in the process, the plastic ball 8 can rise within the cylindrical region 4 because of the buoyancy in the fluid medium, and therefore said ball 8 finally arrives at the opening 6 and can also close the latter, depending on the variant embodiment. Accordingly, the fluid can also pass via the opening 7 into the valve chamber 9. Finally, the quantity of fluid to be metered through the valve chamber 9 is dispensed by the valve 2 via the outlet opening 12 and thus passes to the outside, for example into the interior of a domestic machine. If the liquid to be metered is then conducted to the outside via the outlet 12, the ball 8 also drops downwards with the fluid flow and passes again to the opening 7 which it may also close, depending on the embodiment. The separating element 8 is therefore also drawn downwards in the fluid flow, since there is not sufficient space between the separating element 8 and the walls of the pre-metering container 4 for a quantity of fluid to be able to flow past, which would be sufficient for the ball 8 not to be drawn downwards.

The armature 10 of the bistable valve 2 furthermore comprises two permanent magnets 13 and 14 which are arranged with opposite polarity to each other. The two permanent magnets 13, 14 are fastened fixedly to the armature and therefore in particular cannot change the relative distance thereof from each other either. The armature 10 is mounted movably in a guide sleeve 15. The guide sleeve 15 is manufactured from a non-magnetic plastic. Apart from the permanent magnets 13, 14 and the sealing material 11, the armature tappet 16 is manufactured from the same plastic as the guide sleeve 15. A coil 17 is partially wound around the guide sleeve 15. In this case, the axis of the coil 17 coincides with the axis of movement of the armature 10, which axis is furthermore indicated by a double arrow A.

As already explained, the valve 2 is designed as a bistable valve: it accordingly has two stable states in which the outlet 12 is opened or closed. In FIG. 1, the armature 10 is in the upper position thereof, i.e. the outlet 12 is open and the armature 10 is located at the upper stop 18 of the guide sleeve 15. Furthermore, a ring 19 of magnetizable material (for example iron or magnetizable, stainless steel) is placed into the guide sleeve 15. The center axis of said magnetizable ring 19 likewise coincides with the axis of movement A of the armature 10.

A metal ball 20 made of magnetizable iron/steel is located in a retaining volume 21 above the stop region 18. Said retaining volume 21 is likewise of approximately cylindrical design. The metal ball 20 can move substantially freely therein (apart from magnetic attraction forces). The retaining volume 21 is formed by a molded-on plastic trough. If the entire metering device 1 is, for example, jolted or shaken in another manner, the metal ball 20 correspondingly moves freely within the retaining volume 21. In particular, the conditions forced by the retaining volume 21 are selected in such a manner that the metal ball 20 can move vertically, i.e. up and down in the direction A.

The functioning of the valve can be illustrated as follows:

The initial starting point is that a current does not flow through the coil 17, i.e. said coil itself does not generate a magnetic field. By means of the two permanent magnets 13, 14 which are directed with opposite polarity to each other along the axis A, a quadrupole field is generated which likewise runs (substantially) symmetrically with respect to the axis A vertically through the center of the permanent magnets. If the starting point is that the armature 10 is initially in the lower position, i.e. leaves the outlet 12, this is a stable state, since in this case the permanent magnet 14 and the field generated thereby magnetize the iron of the ring 19 and the resultant action of force fixes the armature 10 in said position, wherein the coil 17 for this aspect should not yet have a current flowing therethrough. In this case, the valve 2 is designed with regard to the iron compounds of the ring 19, the ball 20, the strength of the permanent magnets 13, 14 and with respect to the size and distance ratios of the entire valve 2 in such a manner that said state initially remains stable if a current does not flow through the coil and said coil does not generates a magnetic field, and furthermore also irrespective of the current position of the iron ball 20.

It is now possible to allow a current to flow through the coil 17 in such a manner that such a strong and focused magnetic field is generated as a result, said magnetic field running virtually parallel to the axis of movement A in the interior of the coil, that the armature 10 can be torn out of the previous position thereof and moved upward in the direction of the stop 18. If the metal ball 20 is located at the bottom, i.e. in the direction of the stop 18, as illustrated in FIG. 1, the material of said metal ball is likewise magnetized by the field of the armature magnets.

If voltage is no longer applied to the coil 17 and a current accordingly no longer flows through the latter, then said coil ceases to generate a magnetic field. However, the valve 2 is designed with regard to the iron compounds 19, 20 and its distances and strength of the permanent magnets 13, 14 in such a manner that the attraction force between the armature and the magnetized iron ball 20 suffices in order to hold the armature 10 in the second stable open position thereof on the stop 18 at the top. However, said state (position of the armature in the open state) is only stable for as long as the ball 20 bears against the lower stop 22 of the retaining space.

If the metering device 1 is shaken, for example, by a vigorous impact, by a corresponding acceleration or the like (for example during transportation of the metering device) such that the ball 20 loses contact with the supporting surface 22 and therefore moves further away from the permanent magnet 13 of the armature, then the force between the ball 20 and the field of the permanent magnet 13 of the armature no longer suffices to hold the armature against the upper stop 18, and therefore said armature, attracted by gravity or the attraction force between the permanent magnet 14 and the magnetizable ring 19, is pulled downwards along the direction of movement and therefore closes the outlet 12 again.

If the ball 20 is located in the position thereof on the supporting surface 22 and if, furthermore, the armature 10 is in the upper, open position, i.e. against the stop 18, then the valve may, however, also be closed again by a voltage being applied to the coil 17 in the reverse direction with respect to the above-mentioned voltage and the coil therefore generating a magnetic field which releases the armature again from the previous position thereof and conveys said armature downwards such that it again closes the outlet 12. This is the specified closing of the line opening 12 during operation of the metering device and of the valve, since it is generally not possible here, or is only possible in special applications, for the starting point to be shaking in such a manner. If the voltage which is applied to the coil 17 is immediately switched off again, the attraction between the permanent magnet 14 and the ring 19 again suffices to continue to keep the armature in a stable position in a closed position of the outlet 12.

If, for example, the starting point were a state of the armature closing the metering output 12 (i.e. in the lower position), said armature would initially be kept stable by the interaction between the permanent magnet 14 and the ring 19. It would furthermore be assumed that the metal ball 20 is located lying on the supporting surface 22 in this situation. If the armature 10 were now pressed upwards against the stop 18 purely mechanically counter to the force in effect between the permanent magnet 14 and the ring 19, without applying a voltage to the coil 17, the attraction force between the metal ball 20 and the permanent magnet 13 would suffice for holding said armature in a stable position.

An advantage of this embodiment is that the metering device is generally always closed in particular during transportation. If the metering device is shaken, this has the consequence that the metal ball 20 moves within the retaining space 21. If the coil 17 does not generate a magnetic field at said moment, then the only stable state is that in which the armature 10 closes the outlet 12, at least if the shaking is not of a magnitude such that the entire metering device may possibly be destroyed.

Therefore, for example, in a state in which current does not flow through the coil 17 and said coil does not generate a magnetic field and in which the valve 2 were open, sufficient shaking, for example due to the metering device 1 being removed from the operating region thereof, would move the ball 20 within the retaining space 21 and would therefore close the valve. This results in a significant increase in the safety associated with the metering device 1, since, when the valve is closed, no fluid can pass to the outside via the outlet 12.

Since there are only two stable states (bistable) for switching the valve 2 between an open and closed state, which states can also be maintained in the currentless state of the coil 17, only current pulses are therefore required to switch the valve 2, said current pulses flowing through the coil 17 and therefore a magnetic field sufficient to switch the valve being required temporarily.

In this case, the metering device 1 is oriented in the operating position in such a manner that the outlet is located at the bottom in the direction of gravity and the entry 5 to the storage container is located at the top in the direction of gravity.

Furthermore, not only does the entirety of the features of the exemplary embodiment illustrated in the drawing form an invention but also individual features or combinations of individual features may also form inventions which are independent per se.

### LIST OF DESIGNATIONS

1 Metering device
2 Valve
3 Pre-metering chamber
4 Pre-metering container
5 Entry
6 Opening
7 Opening
8 Separating element
9 Valve chamber
10 Armature
11 Sealing body
12 Metering spout
13 Permanent magnet
14 Permanent magnet
15 Guide sleeve
16 Armature tappet
17 Coil
18 Upper stop
19 Magnetizable ring
20 Magnetizable metal ball
21 Retaining space
22 Lower stop/supporting surface
A Axis of movement
V Storage container

What is claimed is:

1. Metering device (1) for metering a fluid and for conducting a fluid, with a pre-metering chamber (3) for portioning the fluid, characterized in that at least one separating element (8) which is buoyant in the fluid because of buoyancy is provided in the pre-metering chamber (3).

2. Metering device (1) according to one of the preceding claims, characterized in that the separating element (8) itself is designed as a buoyant body.

3. Metering device (1) according to either of the preceding claims, characterized in that the separating element is movable in the direction of gravity.

4. Metering device (1) according to one of the preceding claims, characterized in that there is a storage chamber (V) for storing the fluid, which is connected to the pre-metering chamber (3) via an inlet opening (6).

5. Metering device (1) according to one of the preceding claims, characterized in that, in the operating position of the metering device (1), the storage chamber (V) is always at least partially arranged above the pre-metering chamber (3) in the direction of gravity.

6. Metering device (1) according to one of the preceding claims, characterized in that the separating element (8) has a passage for the throughflow of fluid.

7. Metering device (1) according to one of the preceding claims, characterized in that the passage is formed by the cross-sectional area of the separating element being selected to be smaller than the cross-sectional area of the pre-metering chamber (3).

8. Metering device (1) according to one of the preceding claims, characterized in that the interior space (4) of the pre-metering chamber (3) is of substantially cylindrical design.

9. Metering device (1) according to one of the preceding claims, characterized in that the separating element (8) is of spherical design.

10. Metering device (1) according to one of the preceding claims, characterized in that there is a line opening for discharging the fluid to be metered, and there is a valve (2) which is connected downstream of the pre-metering chamber (3) in the fluid line for opening and closing the line opening (12).

11. Metering device (1) according to one of the preceding claims, characterized in that the valve is designed as a bistable valve (2).

12. Metering device (1) according to one of the preceding claims, characterized in that the valve (2) is electrically activatable.
